(19) United States
(12) Patent Application Publication
(10) Pub. No.: US 2008/0079991 A1
(43) Pub. Date: Apr. 3, 2008

(54) INFORMATION PROCESSING APPARATUS DEVICE DRIVER DELETION METHOD AND STORAGE MEDIUM STORING CONTROL PROGRAM FOR EXECUTING THE METHOD

(75) Inventors: Takashi Horikoshi, Tokyo (JP); Koichi Abe, Yokohama-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 11/774,308

(22) Filed: Jul. 6, 2007

(30) Foreign Application Priority Data
Jul. 7, 2006 (JP) 2006-188242

(51) Int. Cl. G06F 3/12

(52) U.S. Cl. 358/1.15

(57) ABSTRACT

An information processing apparatus having a storage unit configured to store a device driver and an operating system, and a deletion unit configured to delete the device driver, wherein the deletion unit issues a command before deleting the device driver to deactivate a software instance associated with a device corresponding to the device driver.

### BACKGROUND OF THE INVENTION

1. Field of the Invention

The present invention relates to an information processing apparatus and a device driver deletion method.

2. Description of the Related Art

When a device such as a scanner, a printer, or a multifunction peripheral (MFP) is operated, a user connects such a device to a computer and installs a device driver corresponding to the device. When the user purchases a new device or no longer uses an old device, a device driver corresponding to the old device is no longer necessary. Then, the user generally uninstalls the device driver to make effective use of a capacity of a hard disk of the computer (Japanese Patent Application Laid-open No. 2005-115440).

When the user uninstalls the device driver, whether or not the device is connected to the computer depends on the user. For this reason, an uninstaller of the device driver needs to function without a problem regardless of whether or not the device is connected to the computer.

Most uninstallers of a printer driver, a scanner driver, or a MFP driver use a plurality of application program interfaces (hereinafter referred to as APIs) provided by an operating system (OS). Using the API, the uninstaller acquires a hardware ID from an information file (INF) of a device driver. Then, based on the hardware ID, the uninstaller specifies the device to be deleted and deletes the driver of the device.

Such a driver deletion process is properly carried out on most OSs regardless whether or not the device is connected to a personal computer (PC). However, depending on a type of the OS, at a timing of an API call for deleting a device information set which is made at the end of a driver deletion process, an entire device tree can be re-enumerated. As a result, when the entire device tree is re-enumerated, the device connected to the PC is detected owing to a plug-and-play function of the OS. Consequently, reinstallation of the driver which is to be deleted is started.

Conventionally, in order to prevent such a problem, the user has to turn off in advance power supplied to the device or otherwise disconnect the device from the PC.

### SUMMARY OF THE INVENTION

The present invention is directed to a method and apparatus for deleting a device driver without starting a driver reinstallation process even when the device is connected to an apparatus.

According to an aspect of the present invention, an information processing apparatus includes a storage unit configured to store a device driver and an operating system, and a deletion unit configured to delete the device driver. The deletion unit issues a command before deleting the device driver to deactivate a software instance associated with a device corresponding to the device driver.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a block diagram of a configuration of a peripheral apparatus control system including an information processing apparatus and a peripheral apparatus according to an exemplary embodiment of the present invention.

FIG. 2 is a block diagram illustrating an example of a hardware configuration of a PC.

FIG. 3 is a block diagram illustrating an example of a hardware configuration of an MFP.

FIG. 4 illustrates a configuration of a printer driver.

FIG. 5 is a flowchart illustrating a driver uninstall process according to a first exemplary embodiment of the present invention.

FIG. 6 is a flowchart illustrating a driver upgrade process according to a second exemplary embodiment of the present invention.

FIG. 7 is an example of a dialog message.

FIG. 8 is a flowchart illustrating a driver uninstall process according to a third exemplary embodiment of the present invention.

FIG. 9 is a flowchart illustrating a deletion process of the driver when power supplied to a device is turned off.

FIG. 10 is an example of a message (warning dialog message) which is displayed when the printer driver cannot be not deleted.

FIG. 11 illustrating a status request command transmitted from the PC to the MFP to confirm a status of the MFP.

FIG. 12 illustrating status reply commands which indicate a status of the MFP.

FIG. 13 illustrating a power-off command sent from the PC to the MFP to turn off power supplied to the MFP.

FIG. 14 is a flowchart illustrating a data receiving process in the MFP when the MFP receives data sent from the PC.

FIG. 15 is a flowchart illustrating a process in the MFP when the MFP receives data acquisition request from the PC.

FIG. 16 is a flowchart illustrating a driver upgrade process according to a fourth exemplary embodiment of the present invention.

FIG. 17 is a memory map of a storage medium configured to store various types of data processing programs which can be read out by the peripheral apparatus control system.

### DETAILED DESCRIPTION OF THE EMBODIMENTS

Various exemplary embodiments, features, and aspects of the invention will be described in detail below with reference to the drawings. Among the functions (information) cited and described below, those that are not specially and in detail described, are information publicly disclosed in a site of Microsoft Developer Network (MSDN) as of Apr. 27, 2006. The URL of the site of MSDN is http://msdn.microsoft.com/library/default.asp. In the following description, USB is an abbreviation for Universal Serial Bus which enables bidirectional communication. Since the USB is a publicly known interface, detailed description of the USB shall be omitted.

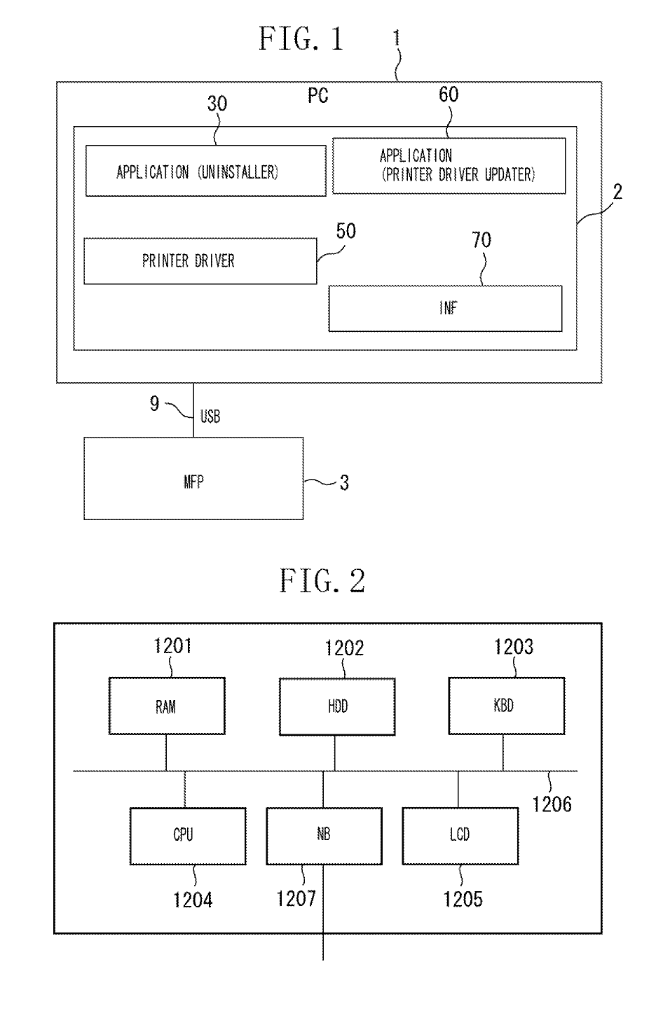

FIG. 1 is a block diagram of a configuration of a peripheral apparatus control system including an information processing apparatus and a peripheral apparatus according to an exemplary embodiment of the present invention. In FIG. 1, an information processing apparatus 1 is a typical PC. The PC 1 includes a hardware which is described later with reference to FIG. 2. Further, an OS 2 is installed in the PC 1.

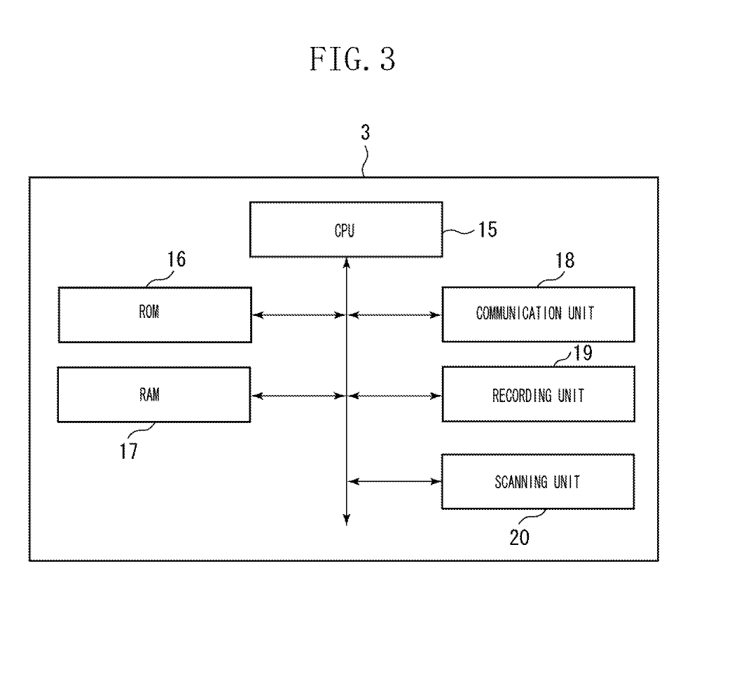

An MFP 3 includes a color scanner and a color inkjet printer. The MFP 3 as described is an example of a peripheral apparatus according to the present embodiment. It is to be noted that a printer, a copier, a fax machine, a scanner, a digital camera, or any apparatus comprising such functions can also be used as the peripheral apparatus of the present embodiment. The MFP 3 includes a hardware configuration described later with reference to FIG. 3. The MFP 3 and the PC 1 are connected via a USB interface 9 which enables bidirectional communication.

An application 30 and an application 60 include a file in an executable file format (*.EXE, etc.). The application 30 is an example of an application according to the present embodiment and serves as an uninstaller configured to delete a driver such as a printer driver or a scanner driver. The application 60 is an updater configured to upgrade such a driver.

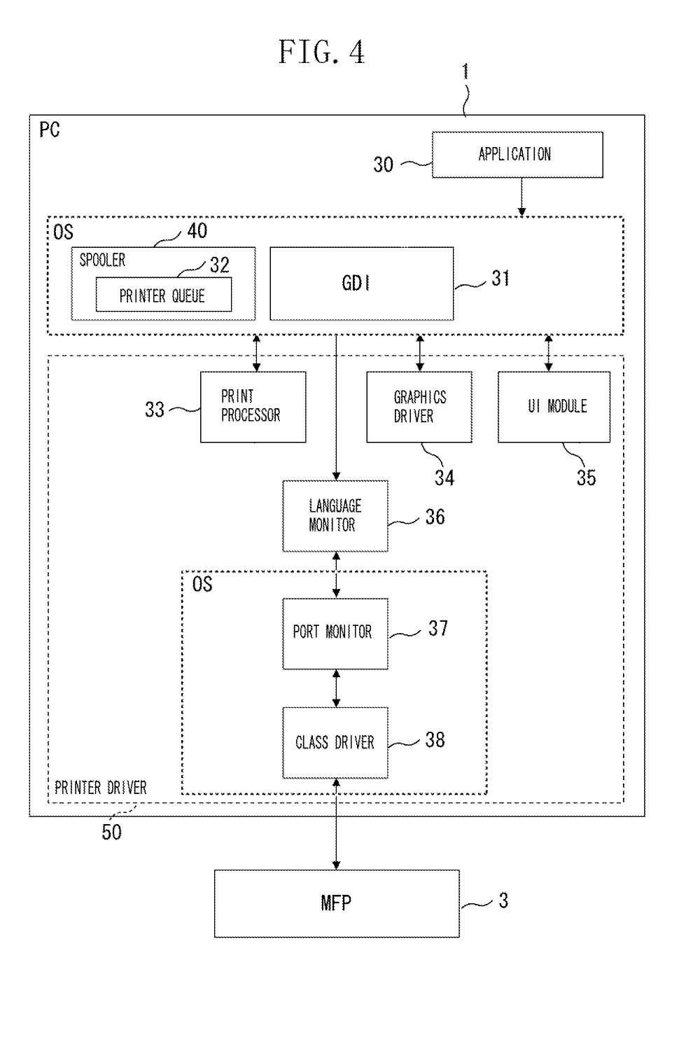

A printer driver 50 is described later in detail referring to FIG. 4. An INF 70 is an information file of the printer driver 50.

FIG. 2 is a block diagram illustrating an example of a hardware configuration of the PC 1. As shown in FIG. 2, the PC 1 includes a random access memory unit (RAM 1201) and a hard disk drive unit (HDD 1202) as a storage unit, and also a keyboard unit (KBD 1203) as an example of an input unit. Further, the PC 1 includes a central processing unit (CPU) 1204 as a control unit, a liquid crystal display (LCD 1205) as an example of a display unit, a network board (NB 1207) as an example of a communication control unit, and a bus 1206 connecting the above-mentioned components of the PC 1.

A portable compact disc read-only memory (CD-ROM) or an internal read-only memory (ROM) can also be used as the storage unit. Modules of the PC 1 illustrated in FIG. 1 (i.e., the applications 30 and 60 and the printer driver 50) are stored in the HDD 1202, read out by the RAM 1201 as needed, and executed by the CPU 1204. Thus, the CPU 1204 realizes functions of these modules illustrated in FIG. 1.

FIG. 3 is a block diagram illustrating a hardware configuration of the MFP 3. In FIG. 3, a CPU 15 includes a microprocessor. According to a program stored in a ROM 16, the CPU 15 which is a central processing apparatus of the MFP 3 controls a RAM 17, a communication unit 18, a recording unit 19, and a scanning unit 20. In FIG. 3, two-way arrows represent an address data bus.

The ROM 16 stores a program configured to allow the MFP 3 to perform a recording (printing) process or transmit a recording (printing) status to the PC 1 under control of the printer driver 50. The RAM 17 temporarily stores print data which is sent from the PC 1 to be printed by the recording unit 19.

The communication unit 18 controls communication via USB and includes a connection port for the USB interface 9. The recording unit 19 includes a recording unit comprising an inkjet-type recording head, color ink tanks, a carriage, and a recording paper feeding mechanism, and also an electric circuit comprising an application specific integrated circuit (ASIC) which generates a print pulse on the recording head based on the print data.

According to a printing operation regarding an application which enables printing, a content (image data) of a file opened by the application is temporarily stored in the HDD 1202 of the PC 1 as a spool file in an enhanced metafile (EMF) format. The content is converted into print data including a command for controlling the MFP 3 by the printer driver 50, and then sent to the MFP 3 via the USB interface 9. The print data is received by the MFP 3, converted into a print pulse by the recording unit 19, and printed on recording paper.

The scanning unit 20 includes a scanning unit including a charge-coupled device (CCD) and a scanning light source, and also an electric circuit including an ASIC configured to process image data scanned by the CCD. The image data controlled by a control command sent from the PC 1 and scanned by the scanning unit 20 is sent to the PC 1 via the USB interface 9.

FIG. 4 illustrates a configuration of a printer driver of the PC 1. The printer driver 50 installed in the PC 1 includes a plurality of modules, that is, a print processor 33, a graphics driver 34, a user interface (UI) module 35, a language monitor 36, a port monitor 37, and a class driver 38. The application 30 enables printing and reading, and also includes an installer of a driver, an uninstaller for deleting a driver, and an updater for upgrading a driver.

A Graphics Device Interface (GDI) 31 is a part of the OS 2. A printer queue 32 is a part of a spooler 40 and used when queuing a print job. The print job in a queue is displayed on a printer queue folder.

The print processor 33 changes a print layout or executes a special processing of a print image. The graphics driver 34 is a core of an image processing performed by the printer driver. Based on a rendering instruction sent from the GDI 31, the graphics driver 34 performs image processing for printing and creates a print control command.

The UI module 35 provides and controls a user interface of the printer driver. The language monitor 36 controls transmission and reception of data as a communication interface. The port monitor 37 transmits data sent from the language monitor 36 to an appropriate port and receives data sent from the MFP 3 via the class driver 38.

The class driver 38 is a low level module which is the closest to the port. According to the present embodiment, the class driver 38 is a USB printer class driver and controls a USB port.

Although a scanner driver of the MFP 3 has a different architecture from the printer driver 50, a basic concept of the scanner driver is similar to that of the printer driver 50 in that it includes an OS module and an independent hardware vendor (IHV) module. For this reason, detailed description of the scanner driver of the MFP 3 is omitted.

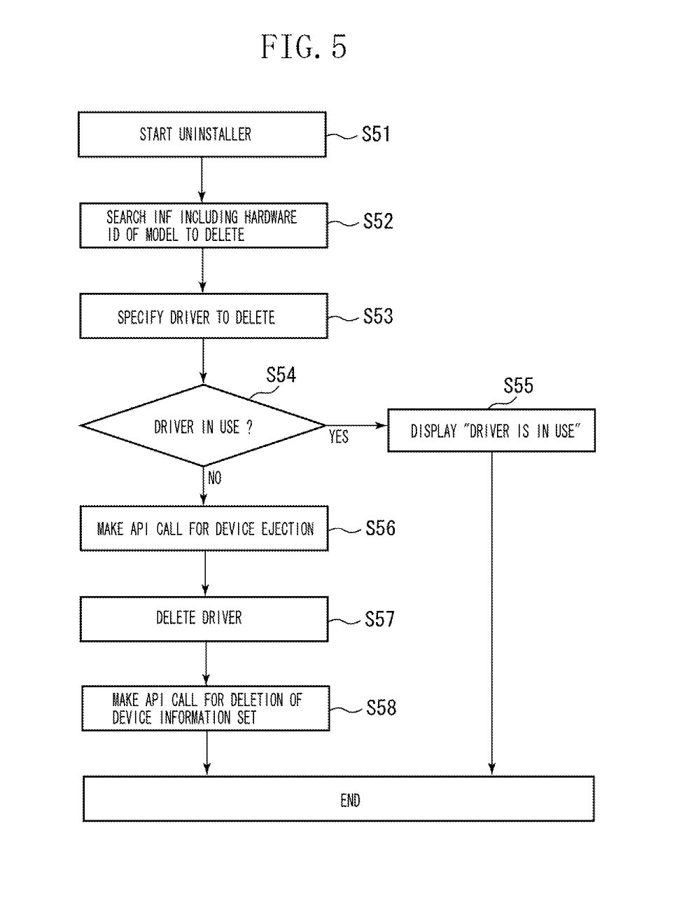

FIG. 5 is a flowchart illustrating an example of an uninstall process of a driver according to the present embodiment. In step S51, the user runs an uninstaller 30 of the MFP 3 and the uninstaller 30 starts the following process. In step S52, the uninstaller 30 searches an INF 70 which contains a hardware ID of the MFP 3 from the all driver INFs installed in the OS 2 using a plurality of APIs provided by the OS 2. In addition, a device information set is created.

Next, in step S53, the uninstaller 30 confirms that the printer driver 50 is to be deleted. Then, in step S54, the uninstaller 30 determines whether the printer driver 50 is being used. If the uninstaller 30 determines that the printer driver 50 is being used (YES in step S54), the process proceeds to step S55. In step S55, an error message is displayed informing the user that the printer driver 50 is being used and the process ends.

On the other hand, if it is determined that the printer driver 50 is not being used (NO in step S54), the process proceeds to step S56. In step S56, the uninstaller 30 makes an API call by which the MFP 3 is removed from a device manager in terms of software. In other words, a device eject API is called and the device manager inactivates an instance of the MFP 3. In this way, plug and play is not enabled by the OS 2 even if a signal for the plug and play is sent from the MFP 3. Until an API for activating the instance is called, the plug and play signal from the MFP 3 is not detected. In other words, when the MFP 3 is removed by the API call in terms of software, plug and play does not occur.

Next, in step S57, the uninstaller 30 deletes the printer driver 50. In step S58, the uninstaller 30 makes an API call to delete a device information set created in step S52. Although the OS 2 re-enumerates the entire device tree when this API is called, since the MFP 3 is already removed by an eject process in terms of software from the device manager of the OS 2 in step S56, the MFP 3 is not detected by the plug and play function of the OS 2 even if the MFP 3 is connected to the PC 1. And S52, device information set is created.

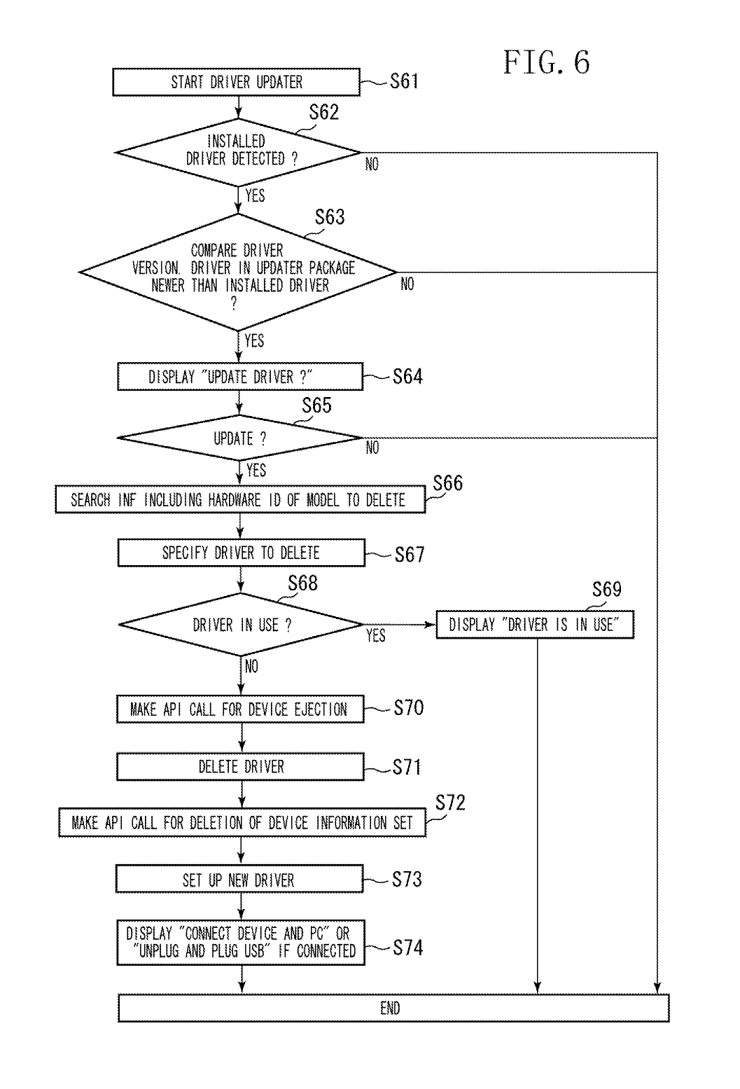

FIG. 6 is a flowchart showing an example of an upgrade process of a driver according to a second exemplary embodiment of the present invention. In step S61, the user runs an updater 60 of the printer driver 50 of the MFP 3. In step S62, the updater 60 detects and determines whether the printer driver 50 is installed.

If the printer driver 50 is not detected (NO in step S62), the process ends. On the other hand, if the printer driver 50 is detected (YES in step S62), the process proceeds to step S63. In step S63, the updater 60 compares a version of a printer driver in an updater package and a version of the printer driver 50 which is already installed.

If it is determined that the version of the installed printer driver 50 is new (NO in step S63), the process ends. On the other hand, if it is determined that the version of the installed printer driver 50 is old (YES in step S63), the process proceeds to step S64. In step S64, the updater 60 displays a dialog asking the user whether the user wishes to update the printer driver.

Next, in step S65, the updater 60 determines whether the user has determined to update the printer driver. If the user has determined not to update the printer driver (NO in step S65), the process ends. On the other hand, if the user has determined to update the printer driver (YES in step S65), the process proceeds to step S66. In step S66, the updater 60 searches the INF 70 which contains a hardware ID of the MFP 3 from the all driver INFs installed in the OS 2 using a plurality of APIs provided by the OS 2. In addition, a device information set is created.

Next, in step S67, the updater 60 confirms that the printer driver 50 is to be deleted. Then, in step S68, the updater 60 determines whether the printer driver 50 is being used. If the updater 60 determines that the printer driver 50 is being used (YES in step S68), the process proceeds to step S69. In step S69, an error message will be displayed informing the user that the printer driver 50 is being used and the process ends.

On the other hand, if it is determined that the printer driver 50 is not in use (NO in step S68), the process proceeds to step S70. In step S70, the updater 60 makes an API call by which the MFP 3 is removed from a device manager in terms of software.

Next, in step S71, the updater 60 deletes the printer driver 50. In step S72, the updater 60 makes an API call to delete a device information set created in step S66.

Although the OS 2 re-enumerates the entire device tree when this API is called, since the MFP 3 is already removed by an eject process in terms of software from the device manager of the OS 2 in step S70, the MFP 3 is not detected by the plug and play function of the OS 2 even if the MFP 3 is connected to the PC 1.

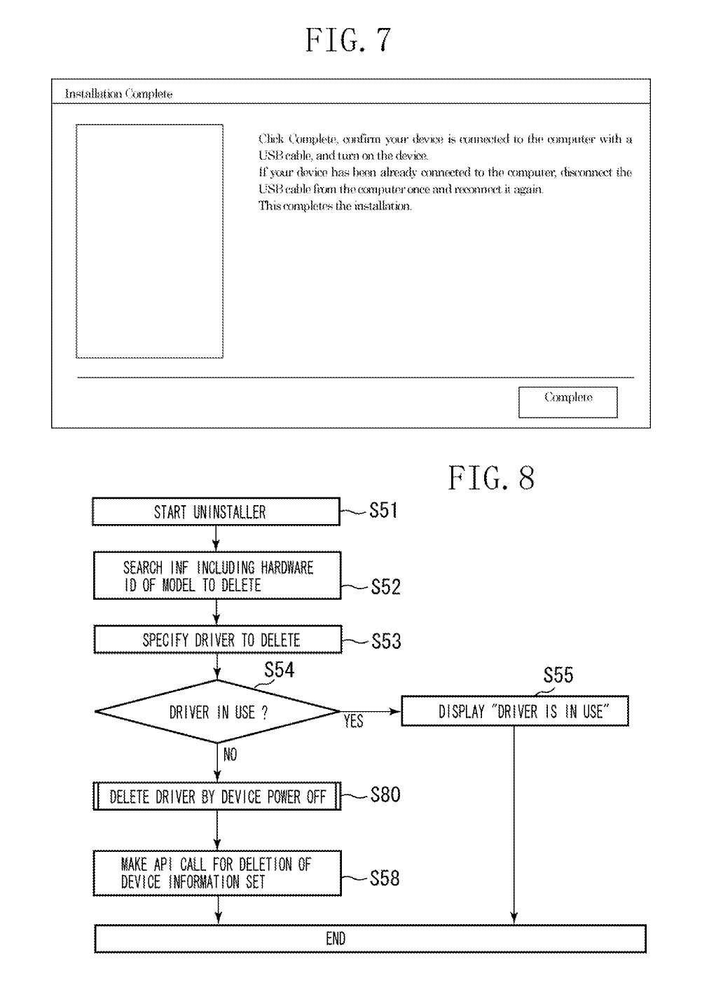

Next, in step S73, a new printer driver is set up by the updater 60. Then, in step S74, the updater 60 displays a dialog message requesting the user to connect the MFP 3 and the PC 1. If the MFP 3 is already connected to the PC 1, the updater 60 displays a dialog message requesting the user to unplug the USB cable and plug it back in. FIG. 7 illustrates an example of the dialog message.

Next, when the user reconnects the USB cable, the OS 2 puts the MFP 3 which has been removed in terms of software, back to the device manager and installs the printer driver by the plug-and-play function.

FIG. 8 is a flowchart illustrating an example of a driver uninstall process according to a third exemplary embodiment of the present invention. In FIG. 8, steps S51, S52, S53, S54, and S55 are the same as those described above with respect to FIG. 5, thus their description is omitted herein.

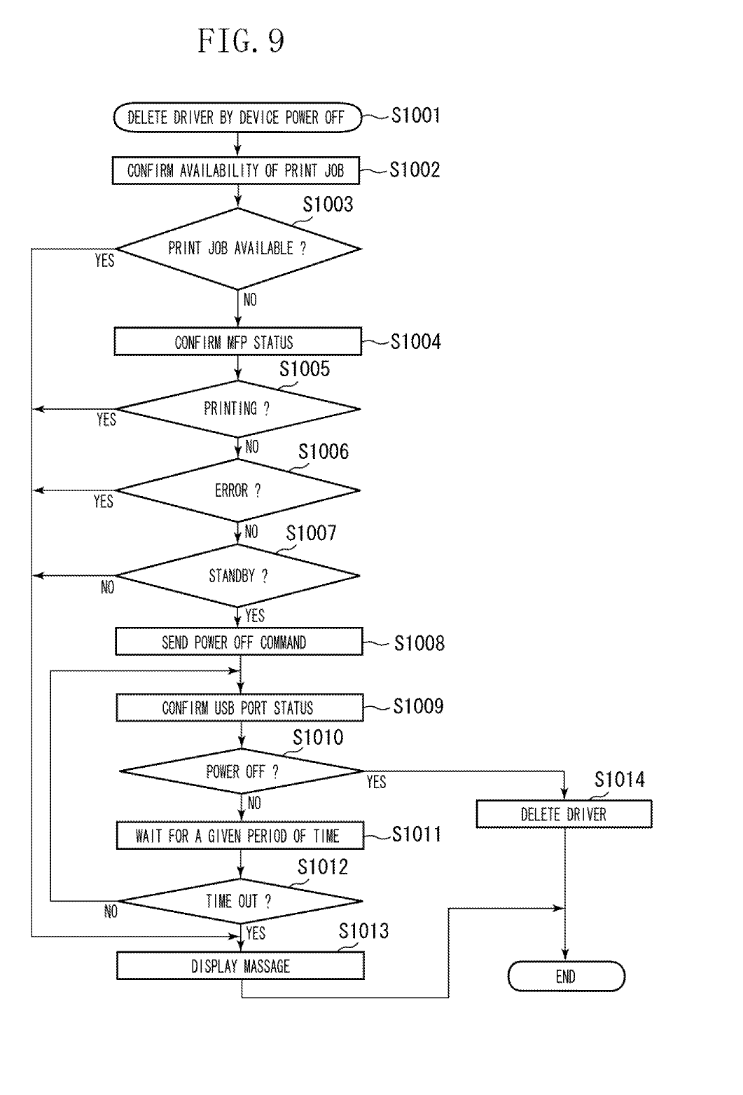

In step S54, if it is determined that the printer driver 50 is not in use (NO in step S54), the process proceeds to step S80. In step S80, the uninstaller 30 deletes the driver by turning off power supplied to the device, as described below with respect to FIG. 9. Next, in step S58, the uninstaller 30 makes an API call to delete a device information set created in step S52. Although the OS 2 re-enumerates the entire device tree when this API is called, since the PC 1 is unable to communicate with the MFP via the USB interface 9 since the power to the device is turned off in step S80, the MFP 3 is not detected by the plug and play function of the OS 2 even if the MFP 3 is connected to the PC 1.

FIG. 9 is a flowchart illustrating a deletion process of the driver when power to the device is turned off. It is to be noted that either the uninstaller 30 or the updater 60 can follow the process described below. In the present embodiment, however, the uninstaller 30 is chosen for the sake of simplicity.

In step S1001, power to the device is turned off and the driver is deleted. Then, the installer 30 performs a following process.

In step S1002, the uninstaller 30 checks a printer queue 32 to see if a print job is in a queue. Then, in step S1003, the uninstaller 30 determines whether the print job is available.

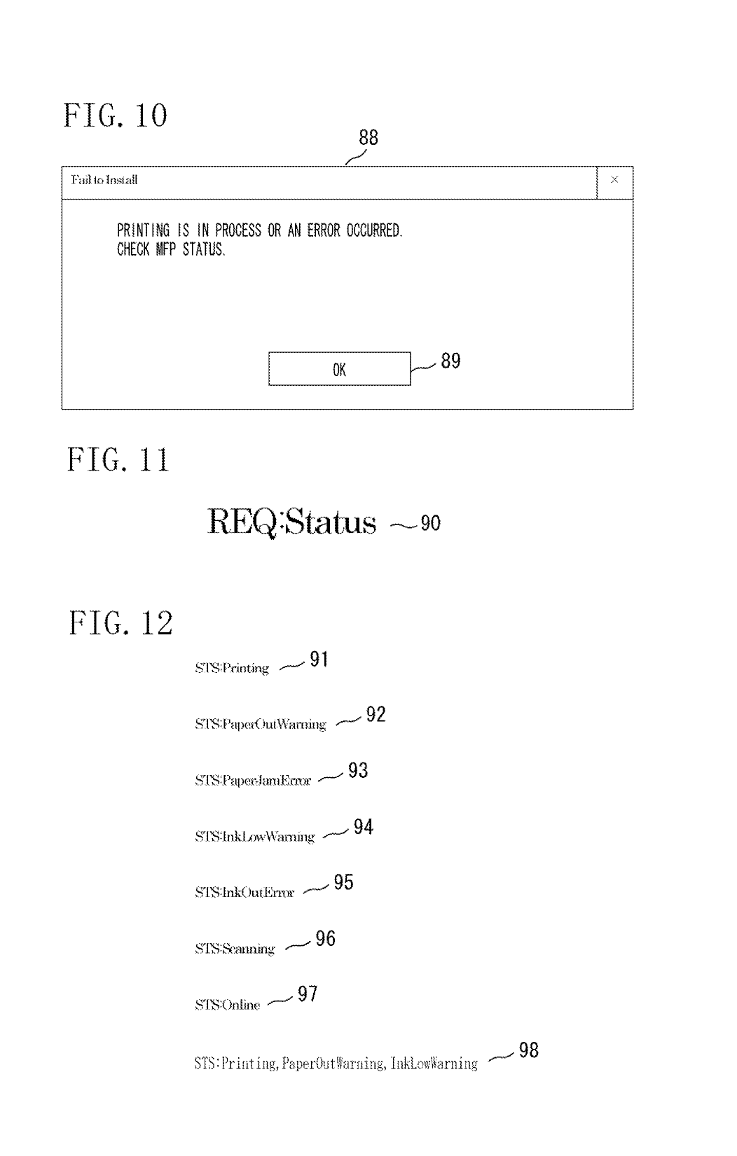

If it is determined that a print job is available (YES in step S1003), the process proceeds to step S1013. In step S1013, the uninstaller 30 displays a message on the display unit that, for example, a print job is present. An example of the message displayed in step S1013 is described below with respect to FIG. 10. On the other hand, if it is determined that a print job is not present (NO in step S1003), the process proceeds to step S1004. In step S1004, using a status request command 90 described below with respect to FIG. 11, the uninstaller 30 confirms a status of the MFP 3 from status reply commands which the MFP 3 returns to the uninstaller 30. The status reply commands are described below with respect to FIG. 12.

In step S1005, the uninstaller 30 determines whether the MFP 3 is in the printing process based on the status confirmed in step S1004. If it is determined that the MFP is in the printing process (YES in step S1004), the process proceeds to step S1013. In step S1013, the uninstaller 30 displays a message on the display unit indicating that, for example, the MFP 3 is the printing process. On the other hand, if it is determined that the MFP is not in the printing process (NO in step S1005), the process proceeds to step S1006. In step S1006, the uninstaller 30 determines whether an error has occurred in the MFP 3 based on the status confirmed in step S1004.

If the uninstaller 30 determines that an error has occurred in the MFP 3, (YES in step S1006), the process proceeds to step S1013. In step S1013, the uninstaller 30 displays, for example, a message informing the user that an error has occurred. On the other hand, if the uninstaller 30 determines that an error has not occurred in the MFP 3 (NO in step S1006), the process proceeds to step S1007. In step S1007, the uninstaller 30 determines whether the MFP 3 is on-line and on standby based on the status confirmed in step S1004.

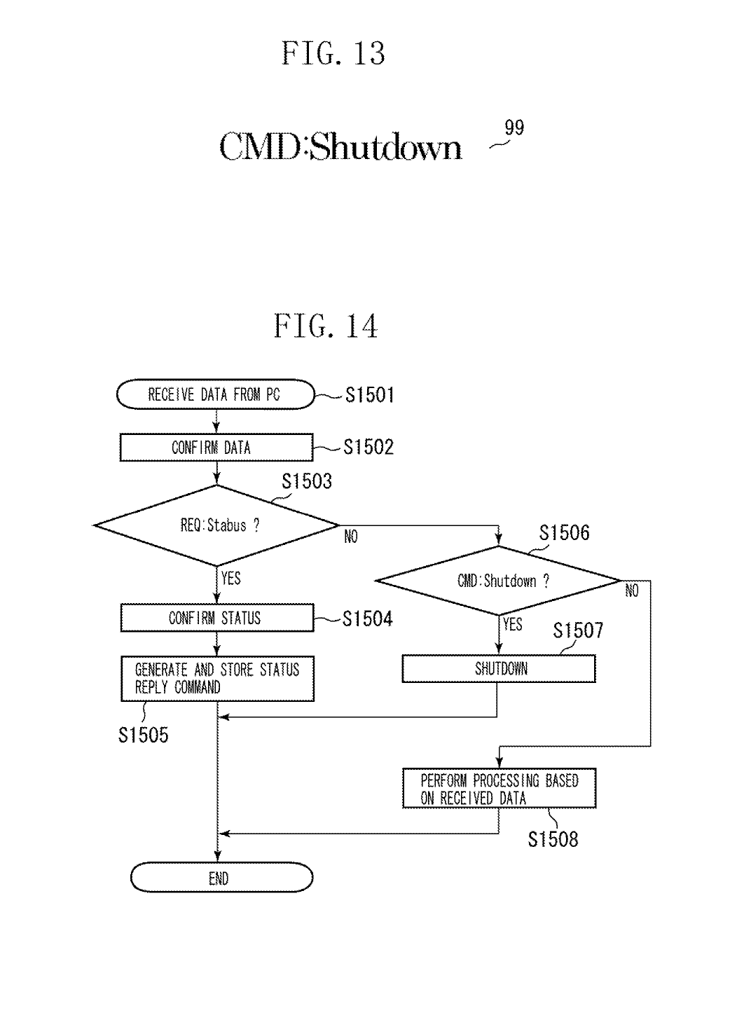

If the uninstaller 30 determines that the MFP 3 is not on-line and on standby (NO in step S1007), the process proceeds to step S1013. In step S1013, the uninstaller 30 displays a message informing the user, for example, that the MFP 3 is not on-line and on standby. On the other hand, if the uninstaller 30 determines that the MFP 3 is on-line and on standby (YES in step S1007), the process proceeds to step S1008. In step S1008, the uninstaller 30 issues and transmits a power-off command to the MFP 3 as described below with respect to FIG. 13.

Then in step S1009, the uninstaller 30 confirms a status of an USB port of the PC 1 to which the USB interface 9 is connected. Next, in step S1010, the uninstaller 30 determines whether the MFP 3 is in a power-off state.

If it is determined that the MFP 3 is in a power-off state (YES in step S1010), the process proceeds to step S1014. In step S1014, the uninstaller 30 deletes the printer driver 50 and the process ends. On the other hand, if it is determined that the MFP 3 is in a power-on state (NO in step S1010), the process proceeds to step S1011. In step S1011, the uninstaller 30 waits for a certain period of time (e.g., 1 second). After that, in step S1012, the uninstaller 30 determines whether a time-out has occurred (e.g., 1 minute has passed).

If the uninstaller 30 determines that the time-out has occurred (YES in step S1012), the process proceeds to step S1013. In step S1013, the uninstaller 30 displays a message on the display unit informing the user, for example, that power is not turned off. On the other hand, if the uninstaller 30 determines that the time-out has not occurred (NO in step S1012), the process returns to step S1009.

When an OK button 89, which is displayed together with the message displayed in step S1013, is selected by the user, the process of deleting the driver by the power-off of the device ends.

The uninstaller 30 performs the process of determining an error of MFP 3 in step S1006, which is described below with respect to FIG. 12. For example, if a warning about a status which does not affect the deletion of the printer driver 50, such as a paper out warning 92 or an ink low warning 94, is detected in step S1004, the process proceeds to perform the deletion process of the printer driver 50. However, if an error which may affect the deletion of the printer driver 50, such as a paper-jam error 93 or an ink-out error 95, is detected in step S1004, the printer driver 50 will not be deleted. In this way, operability is improved while safety is enhanced in the process of the deletion of the printer driver 50.

FIG. 10 illustrates an example of a message (e.g., warning dialog message) which is displayed on the display unit when the printer driver 50 can not be deleted. A warning dialog message 88 notifies the user of a status of the MFP 3 and what the user needs to do. When the OK button 89 is selected, the warning dialog message 88 disappears.

FIG. 11 illustrates a status request command which is transmitted from the PC 1 to the MFP 3 to confirm a status of the MFP 3. Although data transmitted from the PC 1 to the MFP 3 via the USB interface 9 is binary data, in FIG. 11, the binary data is converted into text data for ease of understanding.

FIG. 11 illustrates a status request command 90. When the MFP 3 receives the status request command 90 transmitted from the PC 1 to the MFP 3, the MFP 3 prepares to transmit a status reply command illustrated in FIG. 12 to the PC 1. This process of preparing is described below with respect to FIG. 14. According to the status request command 90 sent from the PC 1, the MFP 3 transmits a status reply command which indicating a present status of preparation, to the PC 1. In this way, the PC 1 confirms the status of the MFP 3.

FIG. 12 illustrates status reply commands which are issued to indicate a status of the MFP 3. A printing status 91 (STS:Printing) is issued to warn the user that the MFP 3 is in the printing process. A paper out status 92 (STS:PaperOutWarning) is issued to warn the user that the print paper is not set in the MFP 3.

The paper-jam error 93 (STS:PaperJamError) is issued when a paper jam occurs in the MFP 3. The ink low warning 94 (STS:InkLowWarning) is issued when ink is running low. The ink-out error 95 (STS:InkOutError) is issued when little ink is left in the MFP 3. A scanning status 96 (STS:Scanning) is issued when the MFP 3 is in a process of scanning. An on-line status 97 (STS:Online) is issued when the MFP 3 is on-line and on a standby state.

When the MFP 3 is in a plurality of statuses, for example, a STS:Printing,PaperOutWarning,InkLowWarning 98 is issued. This command is issued when the MFP 3 is in a process of printing but recording paper is not set, and ink is running low.

FIG. 13 illustrates a power-off command 99 (CMD:Shutdown) sent from the PC 1 to the MFP 3 via the USB interface 9 to turn off power to the MFP 3. When the MFP 3 receives the power-off command 99, the power to the MFP 3 is turned off as illustrated in FIG. 14.

FIG. 14 is a flowchart illustrating a process of the MFP 3 when the MFP 3 receives data from the PC 1. In step S1501, the MFP 3 receives the data from the PC 1.

Next, in step S1502, the MFP 3 confirms the data sent from the PC 1. Then, in step S1503, the MFP 3 determines whether the data is the status request command 90. If it is determined that the data is the status request command 90 (YES in step S1503), the process proceeds to step S1504. In step S1504, the MFP 3 confirms the status of the MFP 3.

Next, in step S1505, the MFP 3 generates and stores a status reply command indicating the state. Then, the process of receiving the data ends.

On the other hand, if it is determined that the data is not the status request command 90 in step S1503, (NO in step S1503), the process proceeds to step S1506. In step S1506, the MFP 3 determines whether the data is the power-off command 99.

If it is determined that the data is the power-off command 99 (YES in step S1506), the process proceeds to step S1507. In step S1507, the power to the MFP 3 is turned off. Then, the MFP 3 ends the process of receiving the data and remains in a power-off state. In step S1506, if it is determined that the data is not the power-off command 99 (NO in step S1506), the process proceeds to step S1508. In step S1508, the MFP 3 performs a process according to the received data and the process of receiving the data ends.

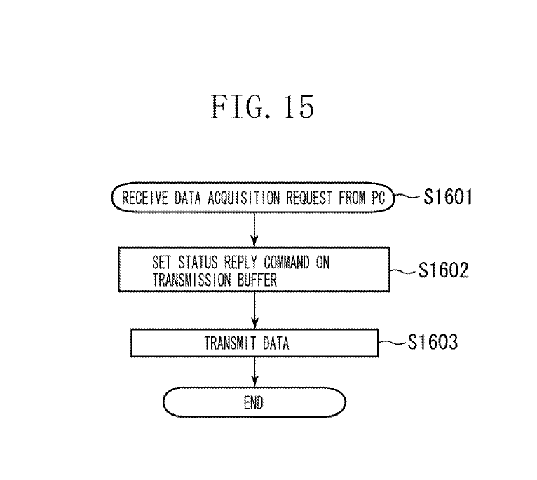

FIG. 15 is a flowchart illustrating a process of the MFP 3 when the MFP 3 receives the data acquisition request from the PC 1. In step S1601, the MFP 3 receives the data acquisition request transmitted from the PC 1.

In step S1602, the MFP 3 sets the status reply command which is stored in step S1505 of FIG. 14 in a data transmission buffer. Next in step S1603, the MFP 3 transmits the data (status reply command) set in the data transmission buffer to the PC 1. Then, the process of receiving the data acquisition request ends. The data acquisition request is created using a protocol which is standardized according to a standard USB specification.

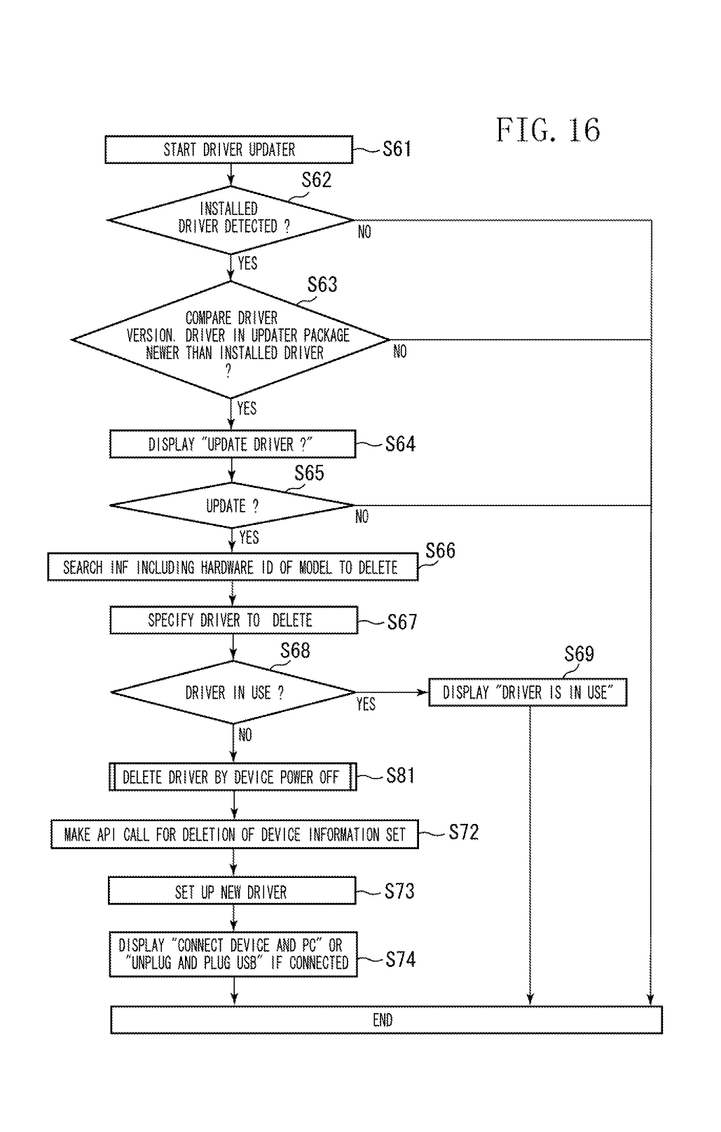

FIG. 16 illustrates an example of a flowchart for an upgrading process of the driver according to a fourth exemplary embodiment of the present invention. In FIG. 16, descriptions of steps S61-S69 are omitted herein since these steps are the same as described above with respect to FIG. 6.

In step S81, the updater 60 deletes the driver by turning off power to the device, as described with respect to FIG. 9. Next, in step S72, the updater 60 makes an API call to delete a device information set created in step S66.

Although the OS 2 re-enumerates the entire device tree when this API is called, since the MFP 3 is already removed from the device manager of the OS 2 by an eject process in terms of software in step S70, the MFP 3 is not detected by the plug and play function of the OS 2 even if the MFP 3 is connected to the PC 1.

Next, in step S73, a new printer driver is set up by the updater 60. Then, in step S74, a dialog message is displayed by the updater 60 requesting the user to connect the MFP 3 and the PC 1. If the MFP 3 is already connected to the PC 1, the updater 60 displays a dialog message requesting the user to unplug the USB cable and plug it back in.

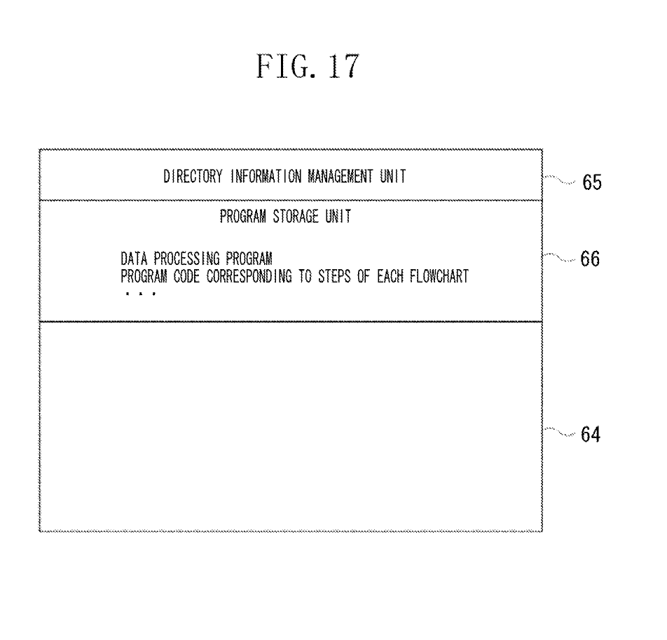

Referring now to a memory map illustrated in FIG. 17, a configuration of a data processing program which can be read out by a peripheral apparatus control system including an information processing apparatus and a peripheral apparatus according to the above-described embodiments will be described.

FIG. 17 is a memory map of a storage medium configured to store various types of data processing programs which can be read out by the peripheral apparatus control system. Although not illustrated, information for managing a program group stored in a storage medium, for example, version information and author information are stored in this storage medium. Furthermore, although not illustrated, information which relies on the OS on a program readout side, for example, an icon or the like used for identifying a program, can also be stored in the storage medium.

In FIG. 17, a storage medium 64 is a hard disk. A directory information management unit 65 controls data which is dependent on various types of programs. A program storage unit 66 stores programs for installing various programs in the information processing apparatus and a decompression program which is used when a program to be installed is compressed.

Also, each function realized by an execution of a process of each flowchart illustrated in FIGS. 5, 6, 8, 9, 14, 15, and 16 according to the above-described embodiments can also be realized by an information processing apparatus using a program installed from an outside device. In this case, the above-described embodiments can also be applied when an information group including a program is provided to the information processing apparatus or a peripheral apparatus from a storage medium such as a CD-ROM, a flash memory, a floppy disk, or an outside storage medium via a network.

As described above, a storage medium storing a software program code which realizes a function of the above-described embodiments is supplied to the peripheral apparatus control system or the information processing apparatus, or the peripheral apparatus. Thus, the object of the above-described embodiments can be also achieved when a computer (or a CPU or a MPU) of the peripheral apparatus control system or the information processing apparatus, or the peripheral apparatus reads and executes the program code stored in such a storage medium.

In this case, the program code itself read out from the storage medium realizes the novel functions described in the above-described embodiments. Thus, the storage medium which stores the program code constitutes the above-described embodiments. As a storage medium which provides the program code, a floppy disk, a hard disk, an optical disk, a magneto-optical disk, a CD-ROM, a CD-R, a magnetic tape, a non-volatile memory card, a ROM, or an EEPROM, etc. may be used.

A function of the above-described embodiments is realized not only when the computer executes the program code. For example, an OS or the like, which runs on a computer, can execute a part or whole of the actual processing based on an instruction of the program code so that a function of the above-described embodiments can be achieved.

Further, the uninstaller and the updater (driver updater) were described in the above-described embodiments as an example, but the application 30 according to the embodiments is not limited to such examples. That is, the application 30 can be an arbitrary application configured to delete a driver of an installer or the like adapted to update or install a driver of a peripheral apparatus.

Furthermore, according to the above-described embodiments, a PC was described as an example of the information processing apparatus, however, the information processing apparatus can be also a DVD video player, a game console, a set-top box, or an Internet appliance.

Further, according to the above-described embodiments, an MFP was selected as an example of the peripheral apparatus, however a peripheral apparatus such as a printer, a copier, a facsimile machine, a scanner, a digital camera, or a multifunction apparatus having these functions can also be used.

Furthermore, according to the above-described embodiments, USB interface was used to interface the PC and the MFP. However, the PC and the MFP can also be connected via Ethernet, wireless Local Area Network (wireless LAN), Institute of Electrical and Electronics Engineers (IEEE) 1394, Bluetooth, Infrared Data Association (IrDA), parallel, or serial interface.

Thus, according to the above-described embodiments, the user can delete the device driver without being disturbed by the driver reinstall processing even when the device is connected to the apparatus.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2006-188242 filed Jul. 7, 2006, which is hereby incorporated by reference herein in its entirety.

What is claimed is:

1. An information processing apparatus comprising:
a storage unit configured to store a device driver and an operating system;
a deletion unit configured to delete the device driver;
wherein the deletion unit issues a command before deleting the device driver to deactivate a software instance associated with a device corresponding to the device driver.

2. The information processing apparatus according to claim 1, wherein the command to remove the device deletes information about the device from information about a device concerning the information processing apparatus managed by the operating system.

3. The information processing apparatus according to claim 1, wherein the device is a peripheral apparatus connected to the information processing apparatus.

4. The information processing apparatus according to claim 1, wherein the deletion unit determines whether a device driver to be deleted is being used, and performs processing for deleting the device driver if the deletion unit determines that the device driver is not being used.

5. The information processing apparatus according to claim 1, wherein plug-and-play processing is not started if the device is removed.

6. An information processing apparatus comprising:
a deletion unit configured to delete a device driver,
wherein the deletion unit turns off power supplied to a device corresponding to the device driver before deleting the device driver.

7. The information processing apparatus according to claim 6, wherein the device is a peripheral apparatus connected to the information processing apparatus.

8. The information processing apparatus according to claim 6, wherein the deletion unit determines whether a device driver to be deleted is being used, and performs processing for deleting the device driver if the deletion unit determines that the device driver to be deleted is not being used.

9. A method for an information processing apparatus comprising:
deleting a device driver, and
issuing a command before deleting the device driver to deactivate a software instance associated with a device corresponding to the device driver.

10. The method according to claim 9, wherein the command to remove the device deletes information about the device concerning the demand, from information about a device concerning the information processing apparatus managed by the operating system.

11. The method according to claim 9, wherein plug-and-play processing is not started if the device is removed.

12. A computer-readable storage medium storing computer-executable process steps, the computer-executable process steps causing a computer to execute the method of claim 9.

13. A method for an information processing apparatus comprising:
deleting a device driver operating, and
turning off power supplied to a device corresponding to the device driver before deleting the device driver.

14. A compute-readable storage medium storing computer-executable process steps, the computer-executable process steps causing a computer to execute the method of claim 13.
